(19) United States
(12) Patent Application Publication
(10) Pub. No.: US 2023/0095656 A1
(43) Pub. Date: Mar. 30, 2023

(54) VANADIUM-BASED SOLUTION, ITS MANUFACTURING METHOD AND A BATTERY THEREOF

(71) Applicant: Standard Energy Inc., Daejeon (KR)

(72) Inventors: Dongyoung Lee, Daejeon (KR); Dongheun Kim, Daejeon (KR); Bugi Kim, Daejeon (KR)

(73) Assignee: Standard Energy Inc., Daejeon (KR)

(21) Appl. No.: 17/952,354

(22) Filed: Sep. 26, 2022

Related U.S. Application Data
(60) Provisional application No. 63/261,702, filed on Sep. 27, 2021.

(30) Foreign Application Priority Data
Aug. 10, 2022 (KR) 10-2022-0100062

(51) Int. Cl. H01M 8/18

(52) U.S. Cl. CPC H01M 8/188; H01M 2300/0005

(57) ABSTRACT

At least some embodiments herein disclose a vanadium-based solution formed by a combination of a vanadium compound, vanadium in metallic form and an appropriate reducing agent. A manufacturing process of the combination foregoes a need of using at least one among a relatively strong reducing agent that subsequently requires removal thereof and using an electrochemical reaction to achieve sufficient chemical reduction of vanadium that is needed for the vanadium-electrolyte solution to act as the liquid electrode in the vanadium-based battery. The liquid electrode, accommodated in a battery case, has an average oxidation state of within a range of +3.3 to +3.7, which is suitable for a catholyte and an anolyte in the battery.

### CROSS-REFERENCE TO RELATED APPLICATIONS

This application claims priority benefit to U.S. Provisional Application No. 63/261,702 filed on Sep. 27, 2021 and Korean Patent Application No. 10-2022-0100062 filed on Aug. 10, 2022.

All of the foregoing are hereby incorporated by reference in their entirety.

### BACKGROUND

The disclosed technology relates to a vanadium-based solution, its manufacturing method and a battery thereof.

The global economic growth accompanied by global warming continues increase the urgency of a need for renewable and sustainable energy systems based on renewable energy, e.g., solar and wind energy. To enhance the stability of grid networks against fluctuations due to intermittent availability such forms of energy, advances in energy storage systems (ESS) are used for storing surplus electricity, which can be delivered to end customers or to power grids when needed. It should be noted that ESS can also be referred to electrical energy storage system (EES). Among others, ESS based on electrochemical energy, e.g., rechargeable or secondary batteries, can provide cost effective and clean forms of energy storage solutions. Examples of electrochemical energy storage systems include lithium-ion, lead-acid, sodium-sulfur and redox-flow batteries. Different storage times are needed for different applications: short-term storage, medium-term storage and long-term storage. The different types of electrochemical energy storage systems have different physical and/or chemical properties. Factors that determine the suitability for a particular application of the electrochemical energy storage systems include investment cost, power, energy, lifetime, recyclability, efficiency, scalability and maintenance cost, to name a few. Competing factors are weighed in the selection and manufacturing of a suitable electrochemical storage system.

### SUMMARY OF THE DISCLOSURE

This Summary of the Disclosure introduces a selection of concepts in simplified form that are described further below in the Detailed Description. This Brief Description neither identifies features as key or essential, nor limits the scope, of the claimed subject matter.

The features related to the vanadium electrolyte disclosed herein are applicable to various types of batteries, such as batteries that have the characteristics of exhibiting redox (reduction-oxidation) chemical reactions. In one aspect, a method of synthesizing an electrolyte for a redox battery comprises providing V₂O₅ and elemental vanadium (V). The method additionally comprises dissolving the V₂O₅ and the elemental V in a solvent to form a solution having dissolved therein vanadium ions and V-based ionic molecules. Providing the V₂O₅ and the elemental V comprises providing a molar ratio of the elemental V to V₂O₅ such that an average oxidation state of vanadium in the electrolyte is >0 and <+5.0.

This disclosure explains about a solution comprising a vanadium compound, vanadium in metallic form and a solvent, wherein a combination of the vanadium compound, the vanadium in metallic form and the solvent results in a vanadium electrolyte suitable for a vanadium-based battery.

Additionally, this disclosure explains about a method of combining a precursor, having a vanadium pentoxide (V₂O₅) and vanadium metal therein, together with an aqueous acid; and obtaining a vanadium-electrolyte solution that contains vanadyl vanadium ions (VO²⁺) and trivalent vanadium ions (V³⁺), the vanadium-electrolyte solution being suitable as both a catholyte implemented in a battery and an anolyte implemented in the battery.

Furthermore, this disclose explains about a battery comprising a case having a first half cell compartment and a second half cell compartment, and a liquid electrode, accommodated in the case, having a particular average oxidation state achieved by previously combining a precursor, having a vanadium pentoxide (V₂O₅) and metal vanadium material therein, with a reducing agent, wherein a combination of the precursor and the reducing agent allow the liquid electrode to exhibit characteristics suitable for a catholyte and an anolyte in the battery.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIGS. 1A-1C are flow charts illustrating example methods of synthesizing an electrolyte using V₂O₅.

FIG. 2 is a flow chart illustrating a method of synthesizing an electrolyte using V₂O₅ and elemental vanadium, according to some embodiments.

FIG. 3 is a flow chart illustrating a method of synthesizing an electrolyte using V₂O₅ and elemental vanadium, according to some other embodiments.

FIG. 4 is a flow chart illustrating a method of synthesizing an electrolyte using V₂O₅ and elemental vanadium, according to some other embodiments.

FIG. 5A is a flow chart illustrating a method of synthesizing an electrolyte using V₂O₅ and elemental vanadium, according to some other embodiments.

FIG. 5B is a flow chart illustrating a method of synthesizing an electrolyte using V₂O₅ and elemental vanadium, according to some other embodiments.

FIG. 5C is a flow chart illustrating a method of synthesizing an electrolyte using V₂O₅ and elemental vanadium, according to some other embodiments.

FIG. 6 illustrates electronic transfer which may occur during synthesis of an electrolyte using V₂O₅ and elemental vanadium.

FIG. 7 shows an exemplary structure of a vanadium-based battery applicable to at least some embodiments described herein.

### DETAILED DESCRIPTION

As discussed above, competing factors that are weighed in the selection and implementation of a suitable electrochemical energy storage system (i.e., ESS or EES) for a particular application includes investment cost, power, energy, lifetime, recyclability, efficiency, scalability and maintenance costs, among others. Among various electrochemical energy storage systems, redox flow batteries (RFBs) are considered to be promising for stationary energy storage. RFBs are electrochemical energy conversion devices, that exploit redox processes of redox species dissolved in a solution. The solution is stored in external tanks and introduced into the RFB cell when needed. Some of the advantageous features of the RFB technology are: independent scalability of power and energy, high depth of discharge (DOD), and reduced environmental impact. Such features allow for wide ranges of operational powers and discharge times, making RFBs desirable for storage of electricity generated from renewable sources.

More recently, vanadium-based batteries, such as, so-called vanadium redox batteries (VRBs), vanadium redox/flow batteries (VRFBs or VFRBs), vanadium flow batteries (VFBs), vanadium ion batteries (VIBs), and the like (some of which are described in U.S. Pat. No. 11,380,928 filed by Applicant, the disclosure of which is incorporated by reference herein in its entirety) are considered to be even more promising for ESS/EES implementation and other applications related to the battery industry. Such vanadium-based batteries have at least some of the same advantages that are characteristic of RFBs. However, unlike RFBs, vanadium-based batteries are significantly less flammable and less prone to damage due to the characteristics of vanadium itself being implemented therein.

In particular, vanadium redox batteries (VRBs) and vanadium ion batteries (VIBs) provide various advantages, including reduced crossover contamination. Some electrolytes for VRBs are synthesized by dissolving vanadium oxide in a solvent and reducing the valency state of vanadium therein to form catholytes and anolytes. However, reducing the valency state of vanadium can be energy, time and/or cost intensive. Thus, the inventors of this disclosure recognized a need for improving the synthesis methods for synthesizing electrolytes that can be specifically used for vanadium-based batteries.

Vanadium has four valence states to form two redox couples, V²⁺/V³⁺ and VO₂⁺/VO²⁺. The cathodic and anodic reactions may be represented as:

Cathodic: VO₂⁺2H⁺+e⁻↔VO²⁺+H₂O

Anodic: V²⁺−e⁻V³⁺

For the above reactions in vanadium-based batteries, it can be said that the (average) oxidation state or oxidation number related to the vanadium solution (or electrolyte) changes to +2 or +3 at the cathode, while the (average) oxidation state or oxidation number related to the vanadium solution (or electrolyte) changes to +4 or +5 at the anode.

As a side note, for vanadium (redox) flow batteries, the redox couples can be Cr/Cr, V/Sn, V/Fe and V/V, or the like. However, the present inventors recognized that VRFBs and VFBs may have certain structural issues that limit their commercial applicability to certain industries and product applications. As such, VIBs or some other types of vanadium-based batteries may be better suited to particular industries and specific applications, as will be further understood in the following explanations.

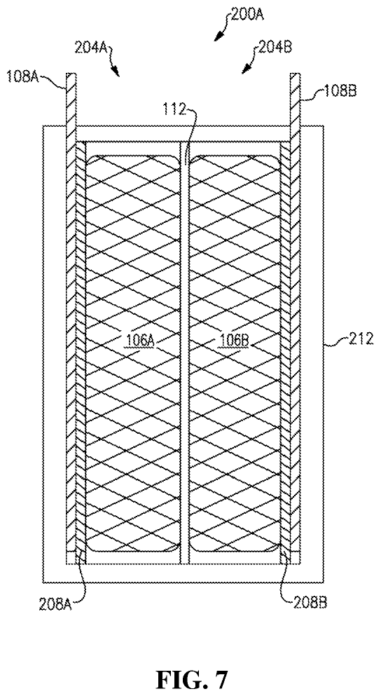

FIG. 7 shows an exemplary structure of a vanadium-based battery according to at least some embodiments described herein.

During charging, in the first half cell 204A, tetravalent vanadium ions V⁴⁺ are oxidized to pentavalent vanadium ions V⁵⁺, while in the second half cell 204B, trivalent ions V³⁺ are reduced to bivalent ions V²⁺. During discharging, in the first half cell 204A, pentavalent vanadium ions V⁵⁺ are reduced to tetravalent vanadium ions V⁴⁺, while in the second half cell 204B, bivalent vanadium ions V²⁺ are oxidized to trivalent vanadium ions V³⁺. While these redox reactions occur, electrons are transferred through an external circuit and certain ions diffuse across the ion exchange membrane 112 to balance electrical neutrality of positive and negative half cells, respectively.

Here, it should be noted that the catholytes and anolytes containing vanadium (i.e., vanadium solutions or vanadium electrolytes) can be referred to as a liquid electrode, which contrasts with those electrodes for batteries that are not vanadium-based. At least some of the inventive features described herein are applicable to such liquid electrodes. Furthermore, for VIBs and some other vanadium-based batteries, the catholyte and the anolyte are not particularly distinguished in their chemical constitution, and thus it can be said that a single type or same liquid electrode is employed to act as both the catholyte and the anolyte. The manufacturing of a liquid electrode to exhibit an average oxidation state +5 or an average oxidation state +4 is relatively easy. However, the present inventors recognized that the manufacturing of a liquid electrode to exhibit an average oxidation state of less than +4, in particular, making a liquid electrode to have an average oxidation state of about +3.5 is technically challenging, but some practical solutions to such challenges have been found and described in more detail hereafter.

VRBs (as well as some other types of vanadium-based batteries such as VIBs) employ vanadium as the only element in both the catholyte and anolyte, thereby providing certain advantages, including lower crossover contamination risk, which allows a long system life of about 15-20 years.

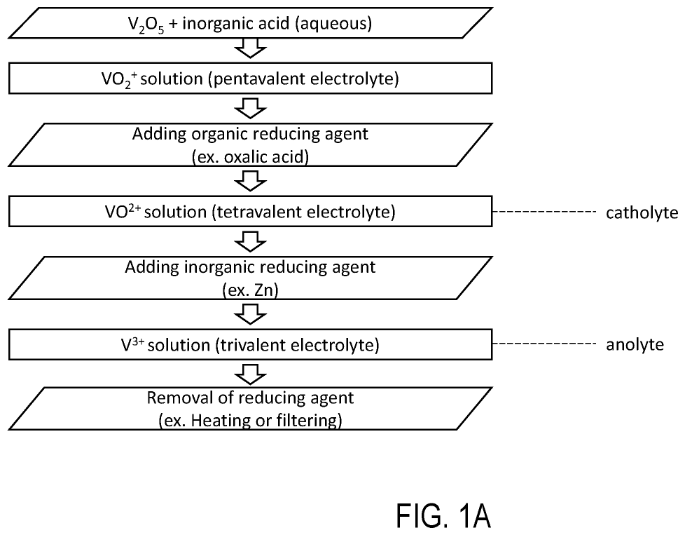

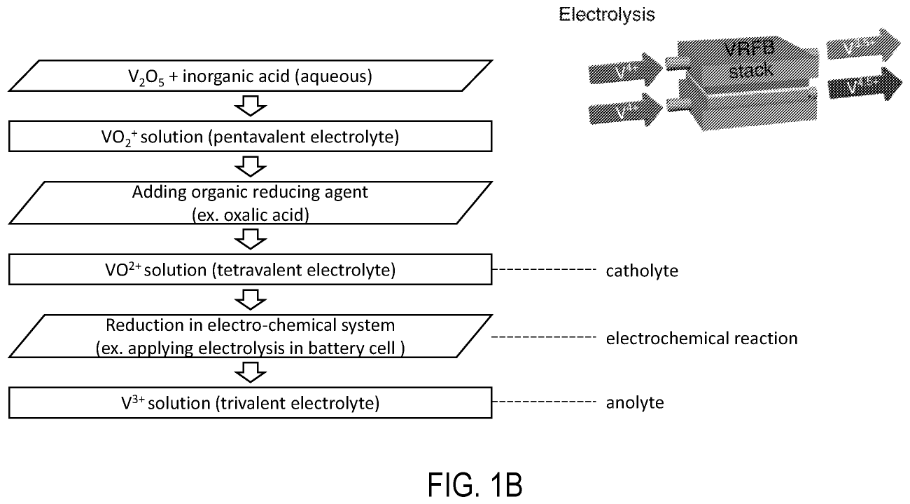

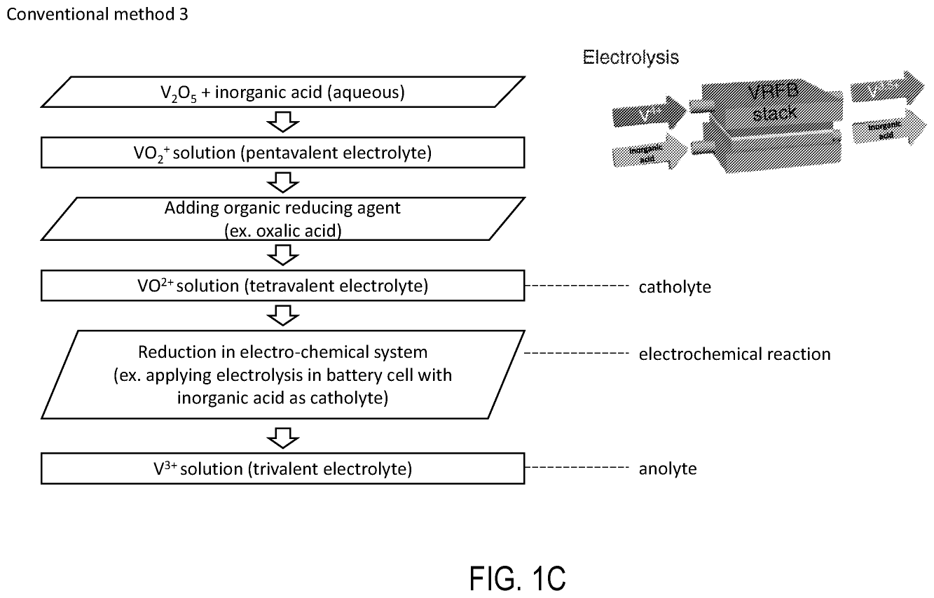

Some electrolytes for VRBs are synthesized by dissolving vanadium pentoxide (V₂O₅) in a solvent and reducing the valency state of vanadium therein to form catholytes and anolytes. Some representative methods are illustrated in FIGS. 1A-1C. However, reducing the valency state of vanadium can be energy, time and/or cost intensive. For example, the methods illustrated in FIGS. 1A-1C utilize reduction agents, which may need to be removed. For organic reduction agents, additional agents or thermal energy may be employed to remove them. Some methods, e.g., those illustrated in FIGS. 1B-1C utilize electrochemical reduction, e.g., electrolysis, which consumes high amounts of energy. Thus, there is a need for improving the synthesis methods for synthesizing electrolytes for VRBs, VIBs and other vanadium-based batteries.

To address these and other needs, according to various embodiments, a method of synthesizing an electrolyte for a vanadium-based redox battery comprises providing V₂O₅ and vanadium in metallic form (so-called elemental vanadium (V)). The method additionally comprises dissolving the V₂O₅ and the elemental V in a solvent to form a solution having dissolved therein vanadium ions and V-based ionic molecules. Providing the V₂O₅ and the elemental V comprises providing a molar ratio of the elemental V to V₂O₅ such that an average oxidation state (or oxidation number) of vanadium in the electrolyte is >0 and <+5.0. By using elemental V, some of the challenges such as removal of reducing agents and/or expenditure of high amounts of energy may be mitigated.

Here, it should be noted that the consideration of adding vanadium in metal form (e.g., elemental V, powder vanadium, etc.) is not a trivial matter. Namely, the present inventors, based upon their recognition that vanadium-based electrolyte synthesis methods need improvement, conducted studies and research with respect to how such improvements should be made. As novel synthesis methods were being developed by the present inventors, various types of testing were conducted to determine what optimal materials and chemical agents should be used. Also, various synthesis conditions, such as manufacturing temperature, specific pH of one or more chemical agents, and the like were considered in depth during testing. As a result of conducting such research and development, the present inventors conceived the following technical concepts and features, as explained in more detail hereafter.

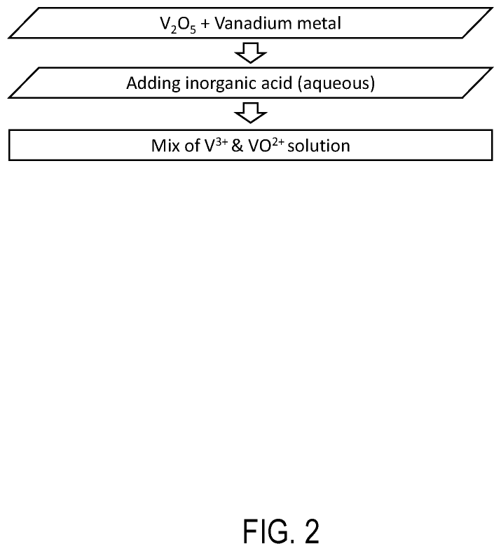

FIG. 2 is a flow chart illustrating a method of synthesizing an electrolyte using V₂O₅ and elemental vanadium, according to some embodiments. The inventors have recognized that, by setting the molar ratio to certain values, the average oxidation state of V may be controlled. In some embodiments, the molar ratio of V₂O₅ /elemental V may be set at ≤2:8 to control the average oxidation state to be ≥+4.0 and 0 and ≤+5.0. In some embodiments, the molar ratio of V₂O₅ /elemental V may be set at 2:8 to 3:7 to control the average oxidation state to be ≥+3.5 and ≤+4.0. In some embodiments, the molar ratio of V₂O₅ /elemental V may be set at 3:7 to 4:6 to control the average oxidation state to be ≥+3.0 and ≤+3.5. In some embodiments, the molar ratio of V₂O₅ /elemental V may be set at 4:6 to 6:4 to control the average oxidation state to be ≥+2.0 and ≤+3.0. In some embodiments, the molar ratio of V₂O₅ /elemental V may be set at ≥6:4 to control the average oxidation state to be >0 and ≤+2.0. The present inventors have found that it may be useful to synthesize the inventive vanadium electrolyte to have an average oxidation state to be about +3.5. They have found that such may ensure suitable battery performance or characteristics for certain types of implementations and applications where vanadium-based batteries are used or installed. There is a trade-off among various factors when manufacturing the inventive vanadium electrolyte according to the embodiments herein.

For example, in order to achieve an average oxidation state to be about +3.5 in the resulting liquid electrode, a vanadium solution in which a specific reducing agent (such as formic acid), a particular catalyst, a manufacturing temperature of over 50 degrees Celsius, a specific reaction time, and a particular agitation procedure are applied to the vanadium solution. Here, the use of certain rare-earth metals (namely, Pt, Ru, Ir, Rh, Ag, Au, etc.) as a catalyst is not needed and certain other metal catalysts, such as, Fe, Ni and Cu are also not necessary. Even a very small or minute presence of any of these catalysts causes undesirable degradation in vanadium-based battery (e.g., VIB) performance, causes undesirable generation of so-called Hydrogen Evolution Reactions (HERs), and/or energy reduction or waste during battery charging or discharging were observed.

Regarding the specific particle size of the vanadium powder, such may be set to about 400 mesh (i.e., around 37 um). If the particle size is too small, the vanadium powder dissolution may take place too easily or too quickly, without allowing the desired lowering of the average oxidation state in obtaining the final liquid electrode. Here, it should be noted that in VFRBs, the use of expensive or costly vanadium is not necessary and the causation of HERs is not a big concern, thus the features described herein may be better suited for VIBs and other types of vanadium-based batteries.

Regarding the specific reducing agent, formic acid, methanol, oxalic acid, and the like all have a redox potential, but for lowering an average oxidation state from +4 to about +3.5, the activation energy is more of a factor than such redox potentials. The actual redox potential for oxalic acid is about 0.32V higher than that of folic acid. However, as reported in scholarly articles in the related industry, formic acid exhibits relatively high the reduction strength for lowering an average oxidation state from +4 to about +3.5 when using a Pt/C catalyst.

Regarding the specific combination of metallic vanadium with formic acid, it was found that lowering an average oxidation state from +4 to about +3.5 when using vanadium metal alone was quite difficult. The desired lowering of the average oxidation state could potentially be achieved if one or more factors of reaction temperature, reaction time, amount of metal vanadium, etc. are increased by an extreme amount, but such control was found to be quite impractical. The present inventors found that adding formic acid to vanadium metal provided satisfactory results, even though formic acid exhibits some redox potential.

To realize the various embodiments disclosed herein, the inventors have recognized that the low dissolution of elemental V in various acids may be a challenge. However, the inventors have recognized various ways to enhance the dissolution of elemental V in various acids. For example, to increase the surface area, the elemental V may be in powder form. For example, the powder may be in powder form with an average particle size of 0.01-0.30 mm. Other factors include controlling the temperature, pH of the acid among other others, as disclosed herein. Each of these factors could be used alone, or two or more factors could be used in various combinations depending upon how the dissolution of vanadium metal powder could be improved. For example, when a relatively small average particle size (e.g., 0.01-0.1 mm) is used, which means that the overall surface area for the vanadium metal powder is relatively high, then use of an acid having relatively low (i.e., weaker) pH may be sufficient. In contrast, when a relatively large average particle size (e.g., 0.2-0.3 mm) is used, which means that the overall surface area for the vanadium metal powder is relatively low, then use of an acid having relatively high (i.e., stronger) pH may be needed in order to ensure sufficient dissolution to occur.

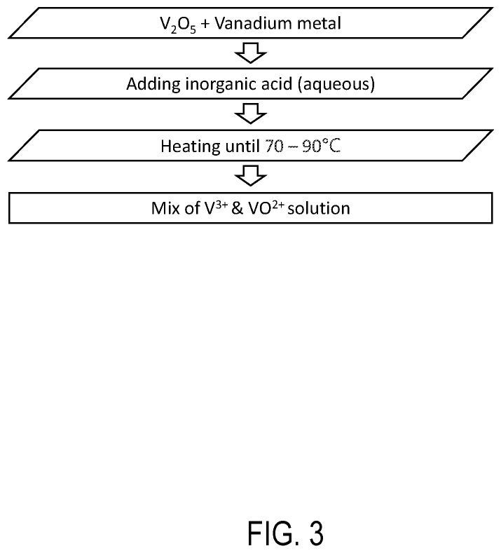

FIG. 3 is a flow chart illustrating a method of synthesizing an electrolyte using V₂O₅ and elemental vanadium, according to some other embodiments. According to various embodiments, the solvent comprises an inorganic acid selected from the group consisting of H₂SO₄, HCl, HNO₃ and H₃PO₄. However, the inventors have recognized that elemental V dissolves in these acids in limited amounts. Thus, according to embodiments, dissolving comprises dissolving the V₂O₅ and the elemental V in the solvent at a temperature greater than room temperature, e.g., at 70-90° C. Here, the temperature may refer to the temperature of the solution itself. Also, there may be situation wherein a temperature of about 60° C. would be sufficient. As such, a reaction temperature range of about 60 to 90° C. would be applicable to the embodiments described herein.

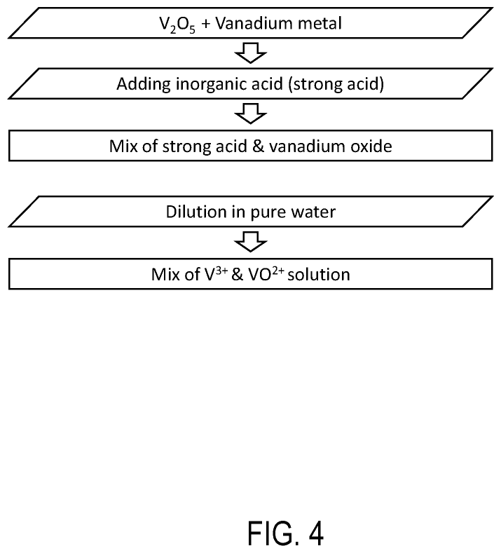

FIG. 4 is a flow chart illustrating a method of synthesizing an electrolyte using V₂O₅ and elemental vanadium, according to some other embodiments. The inventors have recognized that, while elemental V dissolution rate may be higher at elevated acid concentrations, the elevated concentrations may not be suitable for operation of the RFBs in certain applications. Thus, referring to FIG. 4, according to various embodiments, dissolving the V₂O₅ and the elemental V in the solvent comprises dissolving in a strong acid, followed by diluting in H₂O. For example, for H₂SO₄, about a 4M solution may be optimal for operation. However, to enhance manufacturability, the V₂O₅ and the elemental V may be dissolved at much higher concentrations and subsequently diluted to achieve 2M to 5M, for instance about 4M H₂SO₄.

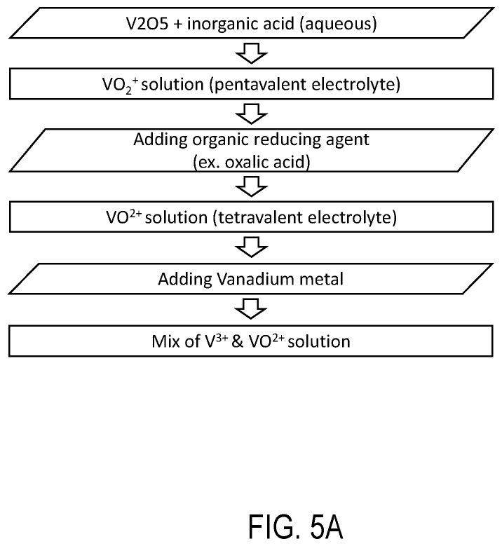

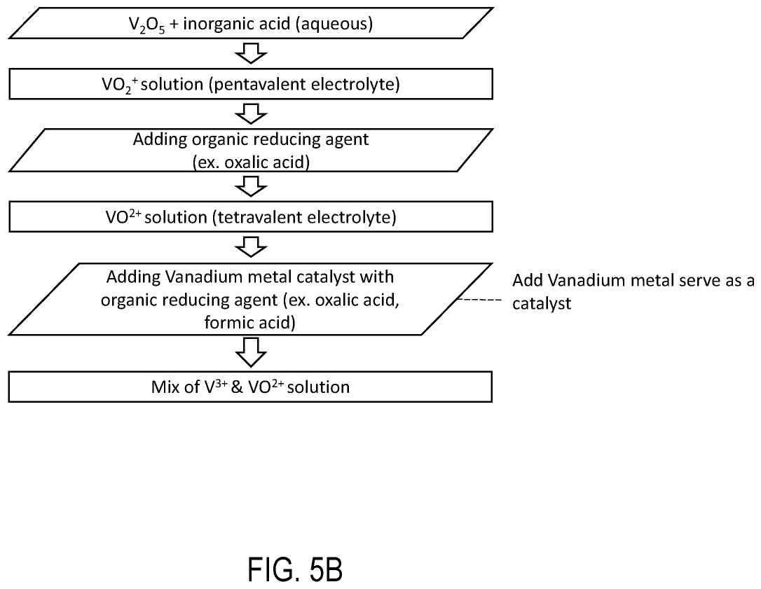

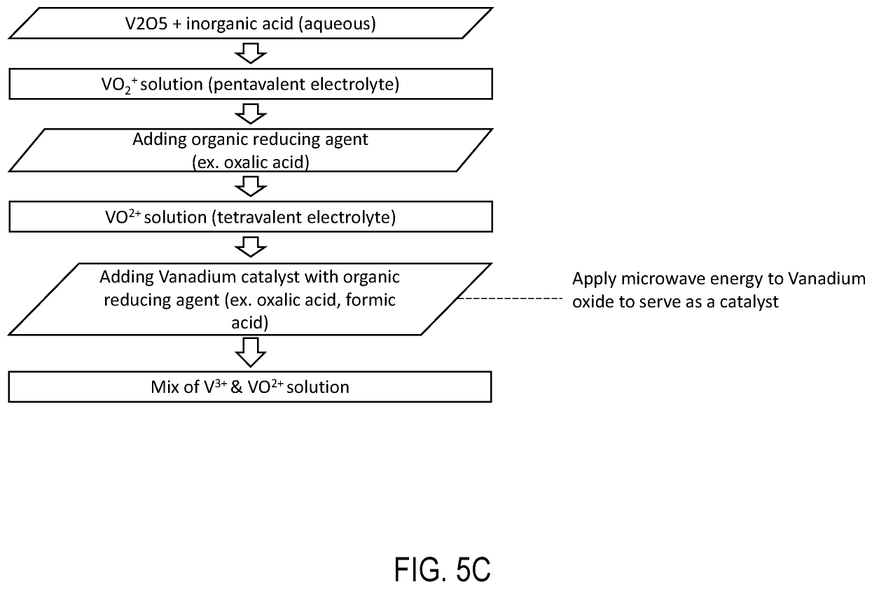

In some embodiments, the V₂O₅ and the elemental V are simultaneously added to the solvent. However, embodiments are not so limited. FIGS. 5A-5C are flow charts illustrating these methods of synthesizing an electrolyte using V₂O₅ and elemental vanadium, according to some other embodiments. In particular, in the illustrated process in FIG. 5A, the V₂O₅ and the elemental V are sequentially added. Sequentially adding the V₂O₅ and the elemental V comprises first adding the V₂O₅ to form VO²⁺, and subsequently adding a reducing agent to form VO²⁺, followed by adding the elemental V. According to the illustrated example in FIG. 5B, elemental V may serve as catalyst. According to the illustrated example in FIG. 5C, vanadium oxide may serve as a catalyst, in conjunction with microwave energy. The microwave energy serves to form a mixture of elemental V and vanadium oxides, which in turn serves as a catalyst. When a catalyst is used, additional electrical energy may not need to be applied.

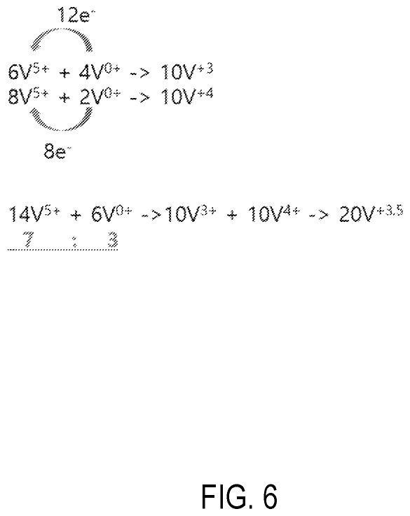

FIG. 6 illustrates electronic transfer which may occur during synthesis of an electrolyte using V₂O₅ and elemental vanadium. Without being bound to any theory, the illustrated transfer process may occur when elemental V is introduced into the solution, which may result in loss of electrons therefrom to the solution. The electrons stripped from the elemental V may subsequently be transferred to V ions, thereby reducing the overall oxidation state of V species in the electrolyte solution. As such, by setting the molar ratio to certain values, the average oxidation state of V may be controlled, as described above with respect to FIG. 2.

Various features with respect to the embodiments can also be explained as follows. Prior to obtaining a liquid electrode having an average oxidation state of +3.5, a vanadium solution having an average oxidation state of +5 may be processed first. Namely, a so-called “+5 vanadium solution” having VOSO₄ and V₂O₅ dissolved therein can be initially reduced to obtain a so-called “+4 vanadium solution.” Thereafter, upon addition of vanadium metal thereto, additional vanadium ions are generated by at least some of the vanadium metal being dissolved. Together with the reducing agent, additional chemical reduction takes place and the average oxidation state of the “+4 vanadium solution” is further lowered to the desired level, such as about +3.5.

As the reducing agent, formic acid, formaldehyde, methanol, oxalic acid, ammonium hydroxide and the like may be used. Such reducing agents have a relatively weak reducing effect, and thus if used alone, would not be sufficient in lowering the average oxidation state from +4 down to the +3 range, but these reducing agents do not cause or minimize the generation of impurities in vanadium-based batteries. As such, in the embodiments herein, vanadium metal and such reducing agents are combined in order to lower the average oxidation state to around +3.5 as desired.

The optimal type of reducing agent to be used may depend upon its applicability and a variety of factors. For example, for reducing the average oxidation state from +5 to +4, oxalic acid may provide the desired results, while formic acid may provide the desired results for reducing the average oxidation state from +4 to +3. Thus, in the embodiments described herein, the specific reducing agent or solvent can be selectively used depending upon where such is being applied. It should be noted that certain sub-reactions caused by the specific type of reducing agent or solvent being used (to manufacture the liquid electrode for a vanadium-based battery) may have greater effect in VIBs than in VFRBs. To minimize such undesirable sub-reactions or other affects, the specific type of reducing agent or solvent may be selectively decided upon.

In such manner, according to the embodiments herein, reduction of the vanadium metal is not as actively progressed when compared to the case where a relatively strong acid, such as sulfuric acid, is used. However, due to the additional use of the reducing agent described above, the intended amount of lowering of the average oxidation state can be achieved by the embodiments described herein.

Turning to a different issue, a small amount of vanadium metal may be undissolved or remain in some other undesirable state within the vanadium solution, vanadium-included electrolyte, and/or the liquid electrode. As such, it may be desirable to remove, neutralize or minimize such residual vanadium metal or the affects thereof, because such may cause undesirable or unintended changes in the average oxidation state of the vanadium solution, vanadium-included electrolyte, or the liquid electrode. To achieve this, the addition amount of at least one among the vanadium metal and the reducing agent can be selectively controlled or adjusted. Such control and/or adjustment would depend upon a variety of factors that should be considered. With the amount of vanadium metal amount being kept constant, the additional amount of the reducing agent may be adjusted. Or with the among of reducing agent being kept constant, the additional amount of the vanadium metal may be adjusted. Alternatively, the respective amounts of both the vanadium metal amount and the reducing agent could be adjusted. Most or all of the residual vanadium metal may need to be removed by filtering or other means, and thus a minimal amount of vanadium metal should be properly determined and initially used for minimizing defects, suppressing abnormal operations and/or achieving manufacturing efficiency.

The two main purposes of removing or minimizing the residual vanadium metal is to effectively get rid of practically all metallic material in the liquid electrode, which may otherwise cause damage or undesirable effects, and also to obtain optimal vanadium electrolyte concentration and/or sustain the average oxidation state thereof (i.e., maintain oxidation state accuracy). To effectively do so, a so-called pressurized filtration procedure is performed and because the residue particles have different sizes, use of appropriate membrane filtering (by employing one or more types of membranes and/or filters having different particle passage rates) is also performed. For example, during the manufacturing process, after appropriately checking the concentration of the vanadium electrolyte (to be used as the liquid electrode) and verifying that the average oxidation state thereof is about +3.5, the pressurized filtration procedure may be performed at least once. It has been observed that the surface color of the vanadium metal particles shows certain changes if chemical reduction sufficiently took place, while other colors on the vanadium metal particles may indicate that reduction was insufficient. Such visual distinctions could also be used to enhance proper filtration.

Also, it has been found that rugged or jagged surfaces on certain vanadium metal particles may cause some damage to the membranes and/or filters used in filtration. As such, observation and care may be needed during the filtration process. More sophisticated membranes and/or filters may be needed for filtration.

After a vanadium solution having an average oxidation state of +4 is manufactured or otherwise obtained, the following experiments were carried out:

In embodiment sample #1, an amount of 100 mg (milligrams) of vanadium metal and 350 μl (microliters) of formic acid were added to 10 ml (milliliters) of a +4 vanadium solution, while comparative sample #1 consisted only of 350 μl (microliters) of formic acid in 10 ml (milliliters) of a +4 vanadium solution (namely, no vanadium metal was added). At the same reaction temperature of 60 degrees Celsius and with all other manufacturing conditions being equal, the vanadium solution of embodiment sample #1 exhibited a lowered average oxidation state of +3.497 (which is virtually at the +3.5 oxidation state that is desired), while the vanadium solution of comparative sample #1 exhibited a lowered average oxidation state of +3.932 (which is practically unchanged from the +4 oxidation state).

The results for comparative sample #1 are because formic acid does not act as a relatively strong reducing agent that achieved the desired oxidation state reduction, and thus the addition of formic acid alone does not result in the desired lowering of the average oxidation state to around +3.5.

In clear contrast, although the same amount of formic acid was used, because embodiment sample #1 included the addition of vanadium metal, the average oxidation state was lowered to around +3.5 (namely, a range from 3.47 to 3.55, or more precisely, within 3.49 to 3.51).

Additionally, upon production of embodiment sample #1, it was found that the overall concentration of the vanadium in the solution increased due to dissolution of the vanadium metal. Namely, the vanadium concentration of the solution in comparative sample #1 was 1.689 M, while that of embodiment sample #1 was 1.894 M. Thus, it can be understood that the average oxidation state was lowered to the desired level, and also the concentration of the vanadium in the solution increased according to the production of embodiment sample #1. Such increased vanadium concentration leads to improved performance in a vanadium-based battery (such as a VIB) that employs a liquid electrode formed according to embodiment sample #1.

In embodiment sample #2, an amount of 50 mg (milligrams) of vanadium metal and 350 μl (microliters) of formic acid were added to 6.5 ml (milliliters) of a +4 vanadium solution, while comparative sample #2 consisted only of 50 mg (milligrams) of vanadium metal added in 6.5 ml (milliliters) of a +4 vanadium solution (namely, no formic acid was added). At the same reaction temperature of 60 degrees Celsius and with all other manufacturing conditions being equal, the vanadium solution of embodiment sample #2 exhibited a lowered average oxidation state of +3.597 (which is virtually at the +3.5 oxidation state that is desired), while the vanadium solution of comparative sample #2 exhibited a lowered average oxidation state of +3.704 (which is much higher than the desired +3.5 oxidation state).

From the results of forming embodiment sample #2 and comparative example #2, it can be understood that the desired lowering of the average oxidation state to about +3.5 is achievable by the combined use of both the vanadium metal and formic acid.

Also, the vanadium concentration of the solution in comparative sample #2 was 1.856 M, while that of embodiment sample #2 was 1.783 M. These results can be compared to those of comparative sample #1 (1.689 M) and embodiment sample #1 (1.894 M) described above. Thus, it can be understood that the results from addition of both vanadium metal and formic acid compared with the results from addition of just vanadium metal (without formic acid) are different.

In addition, although the residual vanadium metal could be obtained upon filtration, the greater the amount of expensive vanadium metal being used, the greater the production costs would be.

The above experimental outcomes, which employed minor amounts of materials, are merely to demonstrate certain comparative results when using vanadium metal and/or formic acid together therewith. However, the similar or equivalent materials, amounts, conditions, procedures, and the like for actual commercial-grade production of the desired vanadium electrolytes and/or the liquid electrodes can be employed and implemented for chemical solutions in larger quantities, such as from 1 L to 10 L, and also applicable to high-capacity output manufacturing in amounts of, for example, 10 L to 1,000 L, as well.

Accordingly, as described thus far, by using a combination of both vanadium metal and a solvent (or reducing agent) such as formic acid, instead of employing just vanadium metal or formic acid alone, the desired average oxidation state for a vanadium solution, vanadium-based electrolyte and/or liquid electrode can be achieved for applications in vanadium-based batteries, such as VIBs.

Additionally, because the vanadium solution (and/or liquid electrode) produced according to the embodiments described herein do not result in impurities and residual materials or only minimal amounts thereof are present, problems related to degraded battery performance can be effectively suppressed. Furthermore, long-term and repetitive charging and recharging of vanadium-based batteries that implement the liquid electrodes according to the embodiments herein can still effectively maintain their performance, characteristics and product longevity.

Also, it can be said that the embodiments described herein, as well as the concepts and details that provide a technical basis thereof, are directed to minimizing the impurities or residual materials due to use of the reducing agent, and also to minimizing the amount of vanadium metal being used to manufacture the desired vanadium electrolyte to be employed as a liquid electrode in a vanadium-based battery.

It should be noted that the vanadium in metallic form (i.e., metal vanadium, vanadium metal, V-metal, etc.) can be manufactured or provided in a variety of ways. As an example, for a solution containing vanadium pentoxide (V₂O₅), an organic material and energy can be applied thereto in order to obtain the desired metal vanadium. The organic material can be carbon in an appropriate form, such as a powder. The energy may be in a particular physical form, such as heat energy, chemical energy, electrical energy and the like. For example, microwave energy can be applied under certain controlled conditions, with respect to energy amount, frequency level, application time, and other manufacturing circumstances. The specific types of organic materials and/or energy to be employed are not limited to those listed above, which are merely exemplary.

Various features related to one or more of the embodiments herein can be described as follows.

At least some embodiments pertain to a solution comprising: a vanadium compound; vanadium in metallic form; and a solvent, wherein a combination of the vanadium compound, the vanadium in metallic form and the solvent results in a vanadium electrolyte suitable for a vanadium-based battery.

Here, the vanadium electrolyte has an average oxidation state within a range of +3.3 to +3.7. Also, the combination is formed by further adding a relatively weak reducing agent to a mixture of the vanadium compound, the vanadium in metallic form and the solvent, whereby the relatively weak reducing agent acting by itself cannot sufficiently lower the average oxidation state, but additional chemical reduction of the vanadium in metallic form due to the added the relatively weak reducing agent results in the average oxidation state to fall within the range of +3.3 to +3.7. 4. Additionally, the vanadium compound is vanadium pentoxide (V₂O₅), the solvent is an inorganic acid selected from the group consisting of H₂SO₄, HCl, HNO₃ and H₃PO₄ and the relatively weak reducing agent is at least one among formic acid, formaldehyde, methanol, ethanol, oxalic acid and ammonium hydroxide. Furthermore, a manufacturing process of the combination foregoes a need of using at least one among a relatively strong reducing agent that subsequently requires removal thereof and using an electrochemical reaction to achieve sufficient chemical reduction of vanadium that is needed for the vanadium-electrolyte solution to act as the liquid electrode in the vanadium-based battery.

Also, at least some embodiments pertain to a method comprising: combining a precursor, having a vanadium pentoxide (V₂O₅) and vanadium metal therein, together with an aqueous acid; and obtaining a vanadium-electrolyte solution that contains vanadyl vanadium ions (VO²⁺) and trivalent vanadium ions (V³⁺), the vanadium-electrolyte solution being suitable as both a catholyte implemented in a battery and an anolyte implemented in the battery.

Here, the vanadium-electrolyte solution is obtained by processing a primary solution to lower its oxidation state such that an average oxidation state of the obtained vanadium-electrolyte solution is within a range of +3.3 to +3.7 due to the combining of the precursor and the aqueous acid with the primary solution. Also, the average oxidation state within the range of +3.3 to +3.7 is at least partial caused by applying a particular molar ratio of the vanadium metal with respect to the vanadium pentoxide (V₂O₅). Additionally, the particular molar ratio is at least one among a range between 2:8 to 3:7 and a range between 3:7 to 4:6. Furthermore, the primary solution is a +5 vanadium solution, which is a vanadium solution having an average oxidation state of about +5, wherein the primary solution has vanadyl sulfate (VOSO₄) or vanadium pentoxide (V₂O₅) dissolved therein. 11. Also, the vanadium metal is a metallic powder form having an average particle size from 0.01 to 0.30 mm. Additionally, the method further comprises: adding a relatively weak reducing agent to a mixture of the vanadium compound and the solvent and adding the vanadium in metallic form to the mixture thereafter. Furthermore, an added amount of at least one among the vanadium in metallic form and the relatively weak reducing agent is selectively adjusted. Also, the relatively weak reducing agent is selected from a group consisting of: formic acid, formaldehyde, methanol, ethanol, oxalic acid and ammonium hydroxide. Additionally, the vanadium in metallic form serves as a catalyst and an organic reducing agent is further added thereto in order to obtain the vanadium-electrolyte solution. Furthermore, the method further comprises: applying microwave energy after adding the organic reducing agent in order to obtain the vanadium-electrolyte solution. Also, the combining of the precursor and the aqueous acid foregoes a need of using at least one among a relatively strong reducing agent, which subsequently requires removal thereof, and an electrochemical reaction to achieve sufficient chemical reduction of vanadium needed for the vanadium-electrolyte solution to act as the catholyte and the anolyte in battery.

Additionally, at least some embodiments pertain to a battery comprising: a case having a first half cell compartment and a second half cell compartment; and a liquid electrode, accommodated in the case, having a particular average oxidation state achieved by previously combining a precursor, having a vanadium pentoxide (V₂O₅) and metal vanadium material therein, with a reducing agent, wherein a combination of the precursor and the reducing agent allow the liquid electrode to exhibit characteristics suitable for a catholyte and an anolyte in the battery.

Here, the reducing agent is one among formic acid, formaldehyde, methanol, ethanol, oxalic acid and ammonium hydroxide. Also, an amount of at least one among the precursor and the reducing agent was selectively controlled or adjusted during the combining prior to being accommodated in the case in order to achieve a desired average oxidation state of the liquid electrode. Additionally, the liquid electrode undergoes filtering to remove or minimize any residual metal vanadium material prior to being accommodated in the case. Furthermore, the particular average oxidation state of within a range of +3.3 to +3.7. Also, the case and the liquid electrode are implemented for a vanadium-base battery that are combined or stacked with other corresponding vanadium-based batteries for installation in an energy storage system.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the essence of the disclosure. For example, while blocks are presented in a given arrangement, alternative embodiments may perform similar functionalities with different components and/or circuit topologies and/or procedures, and some blocks may be deleted, moved, added, subdivided, combined, and/or modified. Each of these blocks may be implemented in a variety of different ways. Any suitable combination of the elements and acts of the various embodiments described above can be combined to provide further embodiments. The various features and processes described above may be implemented independently of one another, or may be combined in various ways. All possible combinations and sub-combinations of features of this disclosure are intended to fall within the scope of this disclosure.

It should be understood that the subject matter defined in the appended claims is not necessarily limited to the specific implementations described above. The specific implementations described above are disclosed as examples only.

What is claimed is:

1. A solution comprising:
a vanadium compound;
vanadium in metallic form; and
a solvent,
wherein a combination of the vanadium compound, the vanadium in metallic form and the solvent results in a vanadium electrolyte suitable for a vanadium-based battery.

2. The solution of claim 1, wherein the vanadium electrolyte has an average oxidation state within a range of +3.3 to +3.7.

3. The solution of claim 2, wherein the combination is formed by further adding a relatively weak reducing agent to a mixture of the vanadium compound, the vanadium in metallic form and the solvent, whereby the relatively weak reducing agent acting by itself cannot sufficiently lower the average oxidation state, but additional chemical reduction of the vanadium in metallic form due to the added the relatively weak reducing agent results in the average oxidation state to fall within the range of +3.3 to +3.7.

4. The solution of claim 3, wherein the vanadium compound is vanadium pentoxide (V₂O₅), the solvent is an inorganic acid selected from the group consisting of H₂SO₄, HCl, HNO₃ and H₃PO₄ and the relatively weak reducing agent is at least one among formic acid, formaldehyde, methanol, ethanol, oxalic acid and ammonium hydroxide.

5. The solution of claim 1, wherein a manufacturing process of the combination foregoes a need of using at least one among a relatively strong reducing agent that subsequently requires removal thereof and using an electrochemical reaction to achieve sufficient chemical reduction of vanadium that is needed for the vanadium-electrolyte solution to act as the liquid electrode in the vanadium-based battery.

6. A method comprising:
combining a precursor, having a vanadium pentoxide (V₂O₅) and vanadium metal therein, together with an aqueous acid; and
obtaining a vanadium-electrolyte solution that contains vanadyl vanadium ions (VO²⁺) and trivalent vanadium ions (V³⁺), the vanadium-electrolyte solution being suitable as both a catholyte implemented in a battery and an anolyte implemented in the battery.

7. The method of claim 6, wherein the vanadium-electrolyte solution is obtained by processing a primary solution to lower its oxidation state such that an average oxidation state of the obtained vanadium-electrolyte solution is within a range of +3.3 to +3.7 due to the combining of the precursor and the aqueous acid with the primary solution.

8. The method of claim 7, wherein the average oxidation state within the range of +3.3 to +3.7 is at least partial caused by applying a particular molar ratio of the vanadium metal with respect to the vanadium pentoxide (V₂O₅).

9. The method of claim 8, wherein the particular molar ratio is at least one among a range between 2:8 to 3:7 and a range between 3:7 to 4:6.

10. The method of claim 7, wherein the primary solution is a +5 vanadium solution, which is a vanadium solution having an average oxidation state of about +5, wherein the primary solution has vanadyl sulfate (VOSO₄) or vanadium pentoxide (V₂O₅) dissolved therein.

11. The method of claim 7, wherein the vanadium metal is a metallic powder form having an average particle size from 0.01 to 0.30 mm.

12. The method of claim 7, further comprising:
adding a relatively weak reducing agent to a mixture of the vanadium compound and the solvent and adding the vanadium in metallic form to the mixture thereafter.

13. The method of claim 12, wherein an added amount of at least one among the vanadium in metallic form and the relatively weak reducing agent is selectively adjusted.

14. The method of claim 12, wherein the relatively weak reducing agent is selected from a group consisting of: formic acid, formaldehyde, methanol, ethanol, oxalic acid and ammonium hydroxide.

15. The method of claim 12, wherein the vanadium in metallic form serves as a catalyst and an organic reducing agent is further added thereto in order to obtain the vanadium-electrolyte solution.

16. The method of claim 12, further comprising:
applying microwave energy after adding the organic reducing agent in order to obtain the vanadium-electrolyte solution.

17. The method of claim 6, wherein the combining of the precursor and the aqueous acid foregoes a need of using at least one among a relatively strong reducing agent, which subsequently requires removal thereof, and an electrochemical reaction to achieve sufficient chemical reduction of vanadium needed for the vanadium-electrolyte solution to act as the catholyte and the anolyte in battery.

18. A battery comprising:
a case having a first half cell compartment and a second half cell compartment; and
a liquid electrode, accommodated in the case, having a particular average oxidation state achieved by previously combining a precursor, having a vanadium pentoxide (V₂O₅) and metal vanadium material therein, with a reducing agent,
wherein a combination of the precursor and the reducing agent allow the liquid electrode to exhibit characteristics suitable for a catholyte in the first half cell compartment and an anolyte in the second half cell compartment.

19. The battery of claim 18, wherein the reducing agent is one among formic acid, formaldehyde, methanol, ethanol, oxalic acid and ammonium hydroxide.

20. The battery of claim 19, wherein an amount of at least one among the precursor and the reducing agent was selectively controlled or adjusted during the combining prior to being accommodated in the case in order to achieve a desired average oxidation state of the liquid electrode.

21. The battery of claim 20, wherein the liquid electrode undergoes filtering to remove or minimize any residual metal vanadium material prior to being accommodated in the case.

22. The battery of claim 20, wherein the particular average oxidation state of within a range of +3.3 to +3.7.

23. The battery of claim 22, wherein the case and the liquid electrode are implemented for a vanadium-base battery that are combined or stacked with other corresponding vanadium-based batteries for installation in an energy storage system.
